(19) United States
(12) Patent Application Publication
(10) Pub. No.: US 2023/0242834 A1
(43) Pub. Date: Aug. 3, 2023

(54) WIRELINE LUBRICANT FOR USE IN GREASELESS DOWNHOLE LOGGING

(71) Applicant: INDUSTRIAL OILS UNLIMITED, L.L.C., Tulsa, OK (US)

(72) Inventor: Michael J Kasbek, Bartlesville, OK (US)

(21) Appl. No.: 18/092,720

(22) Filed: Jan. 3, 2023

Related U.S. Application Data
(60) Provisional application No. 63/296,084, filed on Jan. 3, 2022.

(51) Int. Cl. C10M 173/02; C09K 8/035; C10M 169/04; C10M 107/34; C10M 139/00; C10M 135/36; C10M 141/12

(52) U.S. Cl. CPC C10M 173/02; C09K 8/035; C10M 169/04; C10M 107/34; C10M 139/00; C10M 135/36; C10M 141/12; C09K 2208/34; C10M 2209/1055; C10M 2209/1033; C10M 2227/061; C10M 2219/106; C10M 2201/02

(57) ABSTRACT

A rubber friendly lubricant composition adapted for lubricating the cable in a greaseless down hole logging process including a general formulation: polypropylene glycol, poly alkylene glycol; amine borate; 1,3,4-Thiadiazolidine-2,5-dithione, disodium salt; and, deionized water. The lubricant being compatible with seals and rubbers, and other related materials, used on trucks and other oil field vehicles and equipment. Being water soluble, the lubricant also presents a low potential for fire risk, and is considered environmentally friendly. The lubricant also exhibiting superior freeze properties.

### CROSS-REFERENCE TO RELATED CASES

This application claims the benefit of U.S. provisional patent application Ser. No. 63/296,084, filed on Jan. 3, 2022, and incorporates such provisional application fully by reference into this disclosure as if fully set out at this point.

### FIELD OF THE INVENTION

The present invention relates to lubricants used in greaseless downhole logging applications in the oil and gas industry.

### BACKGROUND OF THE INVENTION

Well logging, as it applies to the petroleum industry, is used to identify oil and gas intervals, and quantify properties of reservoir rock by placing various types of sensors in the borehole. The sensors provide data from which downhole signatures are extrapolated. The signatures are then analyzed to evaluate the formation properties that are of interest for producing oil and gas. Downhole logs are used to determine the physical, chemical, and structural properties of formations penetrated by drilling and to complement discrete core measurements.

Greaseless logging is a wireline application where a cable is fed downhole and the cable actually holds the seal as it is fed down hole. The cable is lubricated as it is going/fed down hole. Traditional cable lube has been used to lubricate the cable.

Traditional cable lubricants used for this application are mineral based products. These fluids are typically over applied to completely cover the cable in the drum, which tends to get the fluid all over the wireline truck. Each user typically employs a different particular method for applying the lubricant to the cable, however, most users flood the cable and/or drum. By flooding the cable and drum, the lubricant undesirably gets all over the wireline vehicle (and possibly other nearby vehicles and equipment). In doing so, the lubricant comes in contact with the seals on the truck/vehicle, and especially the side and back windows, as well as the tires. The rubber and other materials used on window and door seals as well as the tires are not resistant to oils, especially large quantities, but are instead designed to be resistant to water/rain in service. The truck seals and tires are designed to keep rain water out. Since mineral oil does not typically come in contact with these seals and tires, they are not designed to be resistant to mineral oil, particularly in these quantities/amounts. Because of this, users see degradation of tires and window seals, which causes additional replacement costs of truck components on each job. Also, the truck/vehicle (or other equipment) cannot move to the next job unless components are replaced, which causes/compounds additional downtime.

Potential fire risk—Mineral oils have fire points, will ignite, and propagate back to the source. If mineral based products are sprayed onto areas of the wireline trucks that are subjected to high temperatures, such as brake systems, exhaust systems, engine compartments, etc., it is contemplated that the fluid could have a fire risk associated with it.

Freezing properties—Mineral oils can have higher freeze points. During winter operations, glycols and other anti-freezes are pumped downhole prior to cable insertion to ensure smooth operation.

Environmentally friendliness—White oil grade base oils are typically used for these applications. They are non-toxic to aquatic wildlife. They would not be considered readily biodegradable, but depending upon the level of refinement of the mineral oil, could be considered inherently biodegradable. This means they will breakdown in the environment at some point, but not quickly after a release.

A need, therefore, exists for a cable lubricant which does not employ mineral oil or other material which degrades truck/vehicle and equipment components, may present a fire risk, and is not environmentally friendly. A need further exists for a cable lubricant formulation which employs water, which truck/vehicle seals are designed to be in contact with, does not present a fire risk, and is environmentally friendly.

### SUMMARY OF THE INVENTION

The wireline lubricant composition for greaseless down hole logging according to the present invention includes, polypropylene glycol, polyalkylene glycol; amine borate; 1,3,4-Thiadiazolidine-2,5-dithione, disodium salt; and, deionized water. A wireline lubricant formulation according to the present invention is as follows:

| | | |
|---|---|---|
| Propylene Glycol | Base material | 45.0-80% wt. |
| Polyalkylene Glycol | Polymeric glycol, used | 10.0-25% wt. |
| | for lubricity | |
| Amine borate | Rust and corrosion | 0-5.0% wt. |
| | inhibitor (for steel) | |
| 1,3,4-Thiadiazolidine-2,5- | Acid scavenger and | 0-5.0% wt. |
| dithione, disodium salt | yellow metal inhibitor | |
| Deionized Water | Coupler, solubility aid | 10.0-20.0% wt. |

The lubricant composition of the present invention is rubber friendly. While it still lubricates the cable as well as mineral oil, it is compatible with seals and rubbers, and other related materials, used on trucks and other oil field vehicles and equipment. Another benefit of the present invention is that it reduces the cost of maintenance for the operators.

The lubricant product of the present invention is completely water soluble. At levels of propylene glycol and water above 50%, the lubricant product of the present invention is expected to be readily biodegradable.

The lubricant of the present invention provides anti-freeze benefits in winter operations. This is because it has a low freeze point and anti-freeze properties.

### DETAILED DESCRIPTION OF THE PREFERRED EMBODIMENTS

The lubricant composition of the present invention is rubber friendly. While it still lubricates the cable as well as mineral oil, it is compatible with seals and rubbers, and other related materials, used on trucks and other oil field vehicles and equipment.

Another benefit of the lubricant formulation of the present disclosure is that it reduces the cost of maintenance for the operators relating to repair and replacement of vehicles and other equipment. In addition to this benefit, the lubricant of the present invention also provides additional advantages over traditional cable lubes, as described below.
1. Anti-freeze. The lubricant of the present disclosure provides anti-freeze benefits in winter operations as it has a low freeze point and anti-freeze properties. In winter operations, the operators commonly use anti-freeze or other glycols separately, first, downhole, depending on temperature, whereas it is contemplated that this product could double for both.
2. More fire resistant vs. mineral oils. This product contains water and components that are less flammable as compared to mineral oil. Mineral oil could be an issue if left on the truck or is deposited/collecting in hot applications on the trucks/vehicles, such as vehicle braking systems, exhaust systems, or even vehicle motors.
3. Environmentally friendly. The lubricant product of the present disclosure is water soluble, biodegradable and non-toxic. This is especially true since the lubricant material is used for downhole applications.

In a preferred embodiment, the lubricant formulation of the present disclosure includes the following:

1. Propylene Glycol (PG) —25% to 100% (25.0%-85.0%). A person of skill in the art could use technical grade, but could also substitute USP. PG is commercially available from DOW Chemical Company.

2. Water—0%-50% (0.1%-50.0%) —In a most preferred embodiment, water must be de-ionized. De-ionization can be accomplished using filtration of local tap water.

3. Water soluble poly alkylene glycol (PAG), consisting of 40-80% ethylene monomer is 0-80% (0.1%-80.0%) by weight. Water soluble PAG is widely available commercially from suppliers such as DOW, BASF, Novitas, Shrieve, and others.

Amine Borate Rust inhibitor 0-5% (0.1%-5.0%) by weight. Amine borate is available commercially from Colonial Chemical Cola Cor RP and Lubrizol Addco CP-B-2.

Disodium 2,5-dimercapto-1,3,4-thiadiazole in water 0-5% (0.1%-5.0%) by weight. Protects yellow metals under conditions, such as in the presence of high hydrogen sulfide (H₂S) concentrations. Disodium 2,5-dimercapto-1,3,4-thiadiazole is available commercially, such as from RT Vanderbilt Vanchem NATD.

Another, more preferred embodiment of the lubricant formulation of the present disclosure is as follows:

| | | |
|---|---|---|
| Propylene Glycol | Base material | 45.0-85% wt. |
| Polyalkylene Glycol | Polymeric glycol, used | 5.0-25% wt. |
| | for lubricity | |
| Amine borate | Rust and corrosion | 0-5.0% wt. |
| | inhibitor (for steel) | |
| 1,3,4-Thiadiazolidine-2,5- | Acid scavenger and | 0-5.0% wt. |
| dithione, disodium salt | yellow metal inhibitor | |
| Deionized Water | Coupler, solubility aid | 5.0-20.0% wt. |

A most preferred embodiment of the wireline lubricant formulation of the present disclosure is as follows:

| | | |
|---|---|---|
| Propylene Glycol | Base material | 65.0-85% wt. |
| Polyalkylene Glycol | Polymeric glycol, used | 7.0-15% wt. |
| | for lubricity | |
| Amine borate | Rust and corrosion | 0-2.0% wt. |
| | inhibitor | |
| 1,3,4-Thiadiazolidine-2,5- | Acid scavenger and | 0-1.0% wt. |
| dithione, disodium salt | yellow metal inhibitor | |
| Deionized Water | Coupler, solubility aid | 7.0-15.0% wt. |

The lubricant product of the present disclosure is completely water soluble. At levels of propylene glycol and water above 50%, the lubricant product of the present disclosure is expected to be readily biodegradable. Propylene glycol is the preferred base for environmentally friendly anti-freezes and coolants. It is also used in many household products that could be ingested. There is published data on non-toxicity and biodegradability of propylene glycol neat and as a base in formulations.

### Example 1

### Testing:

The following samples were obtained:
1. A sample of the lubricant product formulated according to the most preferred embodiment (hereinafter the “Green sample”).
2. A sample of a mineral based cable lube—DX Cable Lube 70, available commercially from Industrial Oils Unlimited, LLC (hereinafter the “Mineral based sample”).
   The samples were tested for the following:
1. Seal testing with commercially available window seal material.
2. Flash Point.
3. Pour Point.

### Results:

TABLE 1
Sample Results Comparison

| | DX ™ Cable | DX ™ Cable |
|---|---|---|
| | Lube 70 Green | Lube 70 |
| Fluid: | Green sample | Mineral based sample |
| Sample ID: | 20916 | 20755 |
| Test Results: | | |
| Viscosity @ 40 C., | 15.8 | 12.7 |
| cSt | | |
| Viscosity @ 100 C., | N/A | 3.01 |
| cSt | | |
| Viscosity Index* | N/A | 89 |
| Water, ppm | 10% | <100 ppm |

| | |
|---|---|
| Seal Testing | 21 days; 150° F. |

| | | |
|---|---|---|
| Volume Change, % | <1% | −20% |
| Hardness Change | Unchanged | Significant |
| | from new | Brittling and |
| | | hardening |
| Pour Point, C.(F.) | −66 | −30 |
| Flash Point, C. | 271 (520) | 251 (484) |

*Calculated

### Interpretation of Results:

The results can be interpreted as follows:
1. Viscosity @ 40 C—Both samples are similar in viscosity.
2. Viscosity @ 100 C—Due to water content in the Green sample, a viscosity @ 100 C cannot be obtained.
3. Viscosity Index—Because a viscosity @ 100 C cannot be obtained on the Green sample, a VI also cannot be calculated.
4. Water, ppm—The Green sample contains 10% water by weight. The Mineral based sample contains less than 100 ppm water.
5. Seal Testing—The Mineral based sample significantly shrinks and hardens the window seal material, duplicating what is seen in the field. The window seal material remains virtually new with the Green sample under the same lab conditions, indicating a compatibility with the rubber.
6. Pour point—The Green sample will stay fluid down to −66 C in its neat form. As it takes on water, the freeze point will lower, however, even by absorbing 50% its weight in water, it will still not freeze above −40 C. If 50% water is added to the Mineral based sample, it will freeze as it separates from the fluid.
7. Flash point—The flash point is the temperature at which the vapors can ignite in the presence of a spark. The Green sample contains water and will not produce a flash.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A water soluble wireline lubricant composition for greaseless down hole logging, comprising polypropylene glycol, poly alkylene glycol; amine borate; 1,3,4-Thiadiazolidine-2,5-dithione, disodium salt; and, deionized water.

2. The wireline lubricant composition of claim 1 wherein said polypropylene glycol is present at a concentration between about 25.0%-85% wt.

3. The wireline lubricant composition of claim 1 wherein said polypropylene glycol is present at a concentration between about 45%-85% wt.

4. The wireline lubricant composition of claim 1 wherein said polypropylene glycol is present at a concentration between about 65%-85% wt.

5. The wireline lubricant composition of claim 1 wherein said poly alkylene glycol is present at a concentration between about 0.1-80% wt.

6. The wireline lubricant composition of claim 1 wherein said poly alkylene glycol is present at a concentration between about 5%-25% wt.

7. The wireline lubricant composition of claim 1 wherein said amine borate is present at a concentration between about 0.1%-5.0% wt.

8. The wireline lubricant composition of claim 1 wherein said 1,3,4-thiadiazolidine-2,5-dithione disodium salt is present at a concentration between about 0.1%-5% wt.

9. The wireline lubricant composition of claim 1 wherein said deionized water is present at a concentration between about 0.1%-50.0% wt.

10. The wireline lubricant composition of claim 1 wherein said deionized water is present at a concentration between about 10.0%-20.0% wt.

11. The wireline lubricant composition of claim 1 wherein said deionized water is present at a concentration between about 7.0%-15.0% wt.

12. A water soluble wireline lubricant formulation, comprising:
between about 25.0%-100% wt polypropylene glycol;
between about 0.0%-80% wt poly alkylene glycol;
between about 0.0%-5.0% wt amine borate;
between about 0.0%-5% wt 1,3,4-thiadiazolidine-2,5-dithione disodium salt;
between about 0.0%-50.0% wt deionized water.

13. The water soluble wireline lubricant formulation of claim 12 wherein said polypropylene concentration is between about 65%-85%.

14. The water soluble wireline lubricant formulation of claim 12 wherein said poly alkylene glycol concentration is between about 7%-15%.

15. The water soluble wireline lubricant formulation of claim 12 wherein said amine borate concentration is between about 0.0%-2.0%.

16. The water soluble wireline lubricant formulation of claim 12 wherein said 1,3,4-thiadiazolidine-2,5-dithione disodium salt concentration is between 0.0%-1.0%.

17. The water soluble wireline lubricant formulation of claim 12 wherein said deionized water concentration is between 7.0%-15.0%.
